(19) United States
(12) Patent Application Publication
(10) Pub. No.: US 2026/0078210 A1
(43) Pub. Date: Mar. 19, 2026

(54) PRECURSOR COMPOSITIONS COMPRISING A POLYMERIC MATERIAL, A BROMINE-CONTAINING FLAME RETARDANT, AND ANTIMONY TRIOXIDE

(71) Applicant: Northrop Grumman Systems Corporation, Falls Church, VA (US)

(72) Inventors: Nathan A. Spahn, Cumberland, MD (US); Matthew S. Scott, Fort Ashby, WV (US); Brandon C. Durney, Frostburg, MD (US); Gregory B. Fertig, Keyser, WV (US); Craig A. Wilson, Ellerslie, MD (US); Timothy J. Fritz, Cumberland, MD (US)

(21) Appl. No.: 19/402,205

(22) Filed: Nov. 26, 2025

Related U.S. Application Data
(63) Continuation of application No. 16/737,560, filed on Jan. 8, 2020.

(51) Int. Cl. C08F 255/06; B32B 1/00; B32B 27/18; B32B 27/32; C08F 222/10; C08K 3/22; C08K 5/03; C08L 9/06; C08L 23/16; F02K 9/34

(52) U.S. Cl. CPC C08F 255/06; B32B 1/00; B32B 27/18; B32B 27/32; C08F 222/1006; C08K 3/2279; C08K 5/03; C08L 9/06; C08L 23/16; F02K 9/346; B32B 2307/3065; C08L 2201/02; C08L 2201/08; C08L 2205/03; C08L 2205/06; F05D 2230/90

(57) ABSTRACT

An insulation precursor composition comprises ethylene propylene diene monomer, an aramid, and a bromine-containing flame retardant. Rocket motors comprising a case, an energetic material within the case, and an insulation material comprising a reaction produce of ethylene propylene diene monomer, an aramid, and a flame retardant comprising bromine are also disclosed. Related precursor compositions are also disclosed.

### CROSS-REFERENCE TO RELATED APPLICATIONS

This application is a continuation of U.S. patent application Ser. No. 16/737,560, filed Jan. 8, 2020, pending, the disclosure of which is hereby incorporated herein in its entirety by this reference.

### TECHNICAL FIELD

Embodiments of the disclosure relate generally to a precursor composition of an insulation material for use in an article and to methods of insulating the article. More particularly, embodiments of the disclosure relate to a precursor insulation composition including a polymeric material, an aramid material, and a bromine-containing flame retardant for use in various locations on rocket motors or other articles, and methods of insulating a rocket motor or other article.

### BACKGROUND

Solid rocket motors include energetic and non-energetic materials. Improving the performance of a solid rocket motor typically requires increasing the performance of the energetic material (also referred to as a propellant), increasing the mass of energetic material, decreasing the mass of the non-energetic material, or some combination of these modifications. Because solid rocket motors are volume-limited systems, reducing the volume of non-energetic materials in the solid rocket motor allows for an increase in the volume and mass of energetic materials.

The non-energetic materials in a rocket motor may include, for example, a casing, insulation materials, liner materials formulated to promote bonding, and nozzle materials. Reducing the volume of the insulation material may enable a relatively larger volume within the rocket motor to be filled with the energetic material, but may also leave the casing with insufficient thermal protection. Thus, in the design of rocket motors, performance and thermal protection are considered together in developing a system having desired performance parameters and properties.

Rocket motor casings are generally made of metal, a composite material, or a combination of metal and composite materials. During operation, the insulation material protects the rocket motor casing from thermal and erosive effects of particle streams generated by combustion of the energetic material. Typically, the insulation material is bonded to the interior surface of the casing and is fabricated from a composition that, upon curing, is capable of enduring the extreme temperature, pressure, and turbulence conditions produced within the case while the propellant burns. High temperature gases and erosive particles are produced within the casing during combustion of the energetic fuel or propellant. During use and operation, the temperatures inside the casing may reach or exceed about 3,300° C. (about =5,972° F.), pressures can span a range of pressures and typically exceed about 1,500 pounds per square inch (“psi”) (about 10.3 MPa), and velocities of gases may reach or exceed Mach 0.2. These conditions, along with a restrictive throat region provided along a passageway between the casing and the nozzle, combine to create a high degree of turbulence within the casing. In addition, the gases produced during combustion of the fuel or propellant contain high-energy particles that, under a turbulent environment, erode the insulation material. Additionally, if the fuel or propellant penetrates through the insulation material, the casing may melt, be eroded, or otherwise be compromised, causing the rocket motor to fail.

Depending on the configuration of the rocket motor, various combinations of mechanical, thermal, and ablative properties are desired in different sections of the rocket motor. For some sections, higher elongation properties are desirable while for other sections, good ablation and/or good mechanical properties are desirable. Some sections require sufficient electrostatic discharge (ESD) properties, while other sections require sufficient insulative properties.

Due to the extreme environment present within the rocket motor, the insulation of the rocket motor may include a flame retardant. Conventional insulation materials are formed from chlorinated materials, polyurethanes, resorcinol bis(diphenyl phosphate) (RDP), ammonium polyphosphate (AP), or other materials intended to slow or prevent the start or growth of a fire. The insulation materials including chlorinated flame retardants exhibit desired properties. However, due to the harmful effects of various chlorinated materials to the environment, the production and use of the chlorinated materials is strictly regulated. In recent years, many chlorinated materials have become obsolete due to governmental regulation. The obsolescence and unavailability of various chlorinated materials increases the difficultly of fabricating rocket motor insulation materials exhibiting desired properties for use in a rocket motor.

### BRIEF SUMMARY

Embodiments disclosed herein include insulation precursor compositions for forming insulation materials, and to rocket motors including the precursor composition. For example, in accordance with one embodiment, an insulation precursor composition comprises ethylene propylene diene monomer, an aramid, and a bromine-containing flame retardant.

In additional embodiments, a rocket motor comprises a case, an energetic material within the case, and an insulation material within the case, the insulation material comprising a reaction product of ethylene propylene diene monomer, an aramid, and a flame retardant comprising bromine.

In further embodiments, a method of insulating a rocket motor comprises applying a precursor composition of an insulation to at least a portion of a rocket motor and curing the precursor composition to form the insulation. The precursor composition comprises ethylene propylene diene monomer, an aramid, and a flame retardant including one or more materials selected from the group consisting of ethylenebistetrabromophthalimide, decabromodiphenyl ethane, a brominated styrene, a tetrabromobisphenol A bis(2,3-dibromopropyl ether), C₁₅H₁₆O₇Br₄, tris(2,3-dibromoispropyl) isocyanurate, and tetrabromobisphenol A.

### BRIEF DESCRIPTION OF THE DRAWINGS

FIG. 1 is a simplified cross-section of a rocket motor including an insulation material, according to embodiments of the disclosure;

FIG. 2 is simplified cutaway view of a rocket motor nozzle including an insulation material, according to embodiments of the disclosure;

FIG. 3 through FIG. 5 are graphs illustrating the degradation of various insulation materials as a function of mass flux passing the insulation materials, according to embodiments of the disclosure;

FIG. 6 is a SEM image of an insulation material including an ethylenebistetrabromophthalate flame retardant after exposure to propellant combustion gases;

FIG. 7 is a SEM image of an insulation material including an Dechlorane Plus® flame retardant after exposure to propellant combustion gases; and

FIG. 8 is a thermogravimetric curve of insulation the percent weight loss of various materials including different flame retardants as a function of temperature.

### DETAILED DESCRIPTION

Illustrations presented herein are not meant to be actual views of any particular material, component, or system, but are merely idealized representations that are employed to describe embodiments of the disclosure. Additionally, elements common between figures may retain the same numerical designation for convenience and clarity.

The following description provides specific details, such as material types, compositions, material thicknesses, and processing conditions in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional techniques employed in the industry. In addition, the description provided below does not form a complete process flow for forming a precursor composition or an article including the insulation material formed from the precursor composition. Only those process acts and structures necessary to understand the embodiments of the disclosure are described in detail below. Additional acts or materials to form a precursor composition or an article including an insulation material formed from the precursor material may be performed by conventional techniques.

According to embodiments disclosed herein, an insulation material is formed from a precursor insulation composition (which may also be referred to herein simply as a “precursor composition”) comprising a polymeric material (e.g., a polymer of ethylene propylene diene monomer (EPDM)) and a flame retardant. In some embodiments, the precursor composition further includes one or more of (e.g., all of) a co-agent (e.g., linear polybutadiene), a flame retardant synergist (e.g., antimony trioxide), a curing agent, and an aramid. The precursor composition may further include one or more fillers (e.g., carbon nanotubes, carbon nanofibers), a processing aid, an antioxidant, a plasticizer, a cure accelerator, and a tackifier.

The flame retardant may include an aliphatic compound (organic compounds in which the carbon atoms are arranged in open chains (e.g., linear chains, branched chains) rather than aromatic rings), an alicyclic compound (organic compounds including both cyclic structures (e.g., aromatic rings) and aliphatic structures), and aromatic compounds. The flame retardant may include a halogenated compound. In some embodiments, the flame retardant comprises a non-chloro halogenated compound. In other words, in some such embodiments, the flame retardant is substantially free of chlorine atoms. In some embodiments, the flame retardant includes chlorine and at least one other halogen (e.g., fluorine, bromine, iodine). In some embodiments, the flame retardant comprises a brominated compound, an iodinated compound, a fluorinated compound, a compound including bromine atoms and one or more of iodine atoms, chlorine atoms, and fluorine atoms, or a chlorinated compound in combination with one or more of the brominated compound, the iodated compound, or fluorinated compound. In some embodiments, the flame retardant is a bromine-containing compound. In some embodiments, the flame retardant is substantially free of chlorine and the precursor composition does not include (i.e., excludes) a chlorinated compound used as the only (e.g., sole, a single) flame retardant. By way of nonlimiting example, the flame retardant may include one or more of ethylenebistetrabromophthalimide, decabromodiphenyl ethane, a brominated styrene, a tetrabromobisphenol A bis (2,3-dibromopropyl ether), a bromine-containing diester/ether diol of tetrabromophthalic anhydride (e.g., a reactive diol including bromine, such as a compound having the formula C₁₅H₁₆O₇Br₄), tris(2,3-dibromoispropyl) isocyanurate (C₁₂H₁₅Br₆N₃O₃), tetrabromobisphenol A, and other brominated materials.

The precursor composition may be cured, such as by exposure to a temperature greater than about 135° C. (about 275° F.), such as about 177° C. (about 350° F.), in the presence of the curing agent. In some embodiments, the precursor composition is exposed to the temperature for a duration from about 30 minutes to about two hours. During curing, the precursor composition cross-links to form a cross-linked polymeric material including the flame retardant, the co-agent, the flame retardant synergist, the curing agent, and the aramid and, optionally, one or more of a filler, a processing aid, an antioxidant, a plasticizer, a cure accelerator, and a tackifier.

The precursor composition may be cured to form an insulation material comprising a reaction product of the precursor composition. In some embodiments, the precursor composition is applied to an article and subsequently cured to form an insulation material bonded to the article. In other embodiments, the precursor composition is cured to form an insulation material, and the insulation material is bonded to an article.

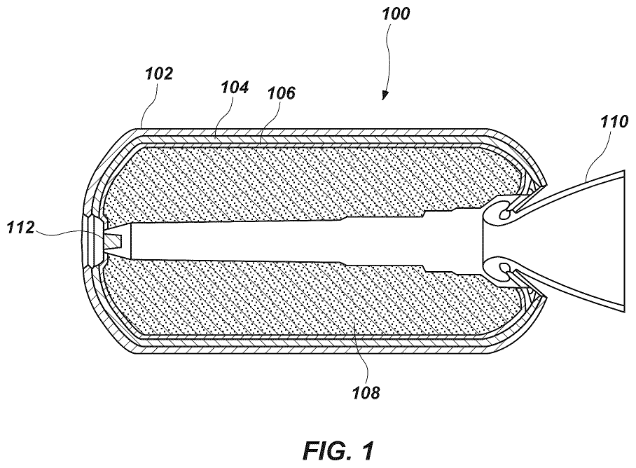

FIG. 1 is a simplified cross-section of a rocket motor 100 including an insulation material, according to embodiments of the disclosure. The rocket motor 100 may include a casing 102, an insulation material 104, a liner 106, and an energetic material 108 (e.g., a solid propellant such as a double-base propellant, an HTPB-based propellant, etc.). The rocket motor 100 may also include a nozzle assembly 110 and an igniter 112. As will be described herein, the insulation material 104 may be formed from an insulation precursor composition including one or more halogenated flame retardants, such as a bromine-containing flame retardant.

The rocket motor 100 may be formed by securing the insulation material 104 within the casing 102 by conventional techniques. For example, the insulation material 104 may be formed within the casing 102 or may be formed as one or more sheets, which are subsequently bonded to the casing 102. The liner 106 is provided over at least a portion of the insulation material 104 and the casing 102. The energetic material 108 is provided (e.g., cast) into the casing 102 over the liner 106.

The energetic material 108 may include at least one propellant material, such as at least one solid propellant. Various examples of suitable solid propellants and components thereof are described in Thakre et al., Solid Propellants, Rocket Propulsion, Vol. 2, Encyclopedia of Aerospace Engineering, John Wiley & Sons, Ltd. 2010, the disclosure of which document is hereby incorporated herein in its entirety by this reference. The energetic material 108 may be a class 4.1, 1.4, or 1.3 material, as defined by the United States Department of Transportation shipping classification, so that transportation restrictions are minimized. By way of non-limiting example, the energetic material 108 may be formed of and include a polymer having one or more of a fuel and an oxidizer incorporated therein. The polymer may be an energetic polymer or a non-energetic polymer, such as glycidyl nitrate (GLYN), nitratomethylmethyloxetane (NMMO), glycidyl azide (GAP), diethyleneglycol triethyleneglycol nitraminodiacetic acid terpolymer (9DT-NIDA), bis(azidomethyl)-oxetane (BAMO), azidomethylmethyl-oxetane (AMMO), nitraminomethyl methyloxetane (NAMMO), bis(difluoroaminomethyl)oxetane (BFMO), difluoroaminomethylmethyloxetane (DFMO), copolymers thereof, cellulose acetate, cellulose acetate butyrate (CAB), nitrocellulose, polyamide (nylon), polyester, polyethylene, polypropylene, polystyrene, polycarbonate, a polyacrylate, a wax, a hydroxyl-terminated polybutadiene (HTPB), a hydroxyl-terminated polyether (HTPE), carboxyl-terminated polybutadiene (CTPB) and carboxyl-terminated polyether (CTPE), diaminoazoxy furazan (DAAF), 2,6-bis(picrylamino)-3,5-dinitropyridine (PYX), a polybutadiene acrylonitrile/acrylic acid copolymer binder (PBAN), polyvinyl chloride (PVC), ethylmethacrylate, acrylonitrile-butadiene-styrene (ABS), a fluoropolymer, polyvinyl alcohol (PVA), or combinations thereof. The polymer may function as a binder, within which the one or more of the fuel and oxidizer is dispersed.

The fuel may be a metal, such as aluminum, nickel, magnesium, silicon, boron, beryllium, zirconium, hafnium, zinc, tungsten, molybdenum, copper, or titanium, or alloys mixtures or compounds thereof, such as aluminum hydride (AlH₃), magnesium hydride (MgH₂), or borane compounds (BH₃). The metal may be used in powder form. The oxidizer may be an inorganic perchlorate, such as ammonium perchlorate or potassium perchlorate, or an inorganic nitrate, such as ammonium nitrate or potassium nitrate. Other oxidizers may also be used, such as hydroxylammonium nitrate (HAN), ammonium dinitramide (ADN), hydrazinium nitroformate, a nitramine, such as cyclotetramethylene tetranitramine (HMX), cyclotrimethylene trinitramine (RDX), 2,4,6,8,10,12-hexanitro-2,4,6,8,10,12-hexaazaisowurtzitane (CL-20 or HNIW), and/or 4,10-dinitro-2,6,8,12-tetraoxa-4,10-diazatetracyclo-[5.5.0.0^{5,9}.0^{3,11}]-dodecane (TEX). In addition, the energetic material 108 may include additional components, such as one or more of a plasticizer, a bonding agent, a combustion rate modifier, a ballistic modifier, a cure catalyst, an antioxidant, and a pot life extender, depending on the desired properties of the propellant. These additional components are well known in the rocket motor art and, therefore, are not described in detail herein. The components of the propellant of the energetic material 108 may be combined by conventional techniques, which are not described in detail herein.

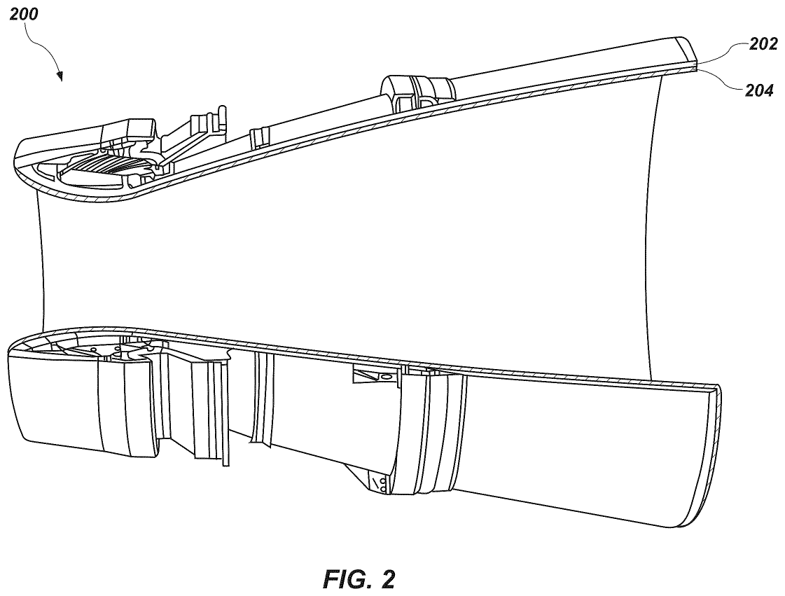

FIG. 2 is a simplified cutaway view of a rocket motor nozzle 200 including an insulation material according to embodiments of disclosure. The rocket motor nozzle 200 may include an outer wall 202 and an insulation material 204. The outer wall 202 may include a material formulated to provide a physical structure over which the insulation material 204 is formed. For example, the outer wall 202 may include a metal or a composite material.

The insulation materials 104, 204 may be formed from a precursor insulation composition. The precursor composition may include a polymeric material, a halogenated flame retardant, a co-agent, a flame retardant synergist, a curing agent, and an aramid. In some embodiments, the precursor composition further comprises one or more of a filler, a processing aid, an antioxidant, a plasticizer, a cure accelerator, and a tackifier.

The polymeric material may include one or more of EPDM terpolymer, polyisoprene, nitride butadiene rubber (NBR), or hydroxyl-terminated polybutadiene rubber. In some embodiments, the polymeric material comprises EPDM terpolymer, which is a terpolymer of ethylene, propylene, and a non-conjugated diene.

In embodiments where the polymeric material comprises EPDM, the EPDM may be linear or branched. Using a linear EPDM or branched EPDM may affect one or more properties of the uncured precursor composition, properties of the cured precursor composition (e.g., the insulation materials 104, 204), and the extent of cross-linking of the cured precursor composition (e.g., the insulation materials 104, 204).

The non-conjugated diene of the EPDM may include, for example, ethylidene nobornene (ENB). The EPDM may have a diene content from about 0.5 weight percent to about 10.0 weight percent, such as from about 0.5 weight percent to about 5.0 weight percent, or from about 5.0 weight percent to about 10.0 weight percent. In some embodiments, the diene content of the EPDM is from about 4.0 weight percent to about 5.0 weight percent. In some embodiments, the diene content of the EPDM is about 5.0 weight percent. In other embodiments, the diene content of the EPDM is about 4.6 weight percent. However, the disclosure is not so limited and the diene content of the EPDM may be different than those described above.

The EPDM may have an ethylene content from about 50 weight percent to about 60 weight percent, such as from about 50 weight percent to about 55 weight percent, or from about 55 weight percent to about 60 weight percent. In some embodiments, the ethylene content of the EPDM is about 55 weight percent. The EPDM may have a propylene content from about 35 weight percent to about 45 weight percent, such as from about 35 weight percent to about 40 weight percent, or from about 40 weight percent to about 45 weight percent. In some embodiments, the propylene content of the EPDM is about 40 weight percent.

The EPDM may be commercially available from the DOW Chemical Company of Midland, Michigan under the NORDEL® tradename; from Lion Elastomers of Port Neches, Texas under the Royalene® tradename; or from LANXESS Deutschland GmbH of Marl, Germany under the KELTAN® tradename. By way of non-limiting example, the EPDM may be NORDEL® IP 4640 or Royalene® 511 EPDM.

The EPDM may be present in the precursor composition from about 45 weight percent to about 60 weight percent, such as from about 45 weight percent to about 50 weight percent, from about 50 weight percent to about 55 weight percent, or from about 55 weight percent to about 60 weight percent of the precursor composition. In some embodiments, the EPDM constitutes from about 50 to about 55 weight percent of the precursor composition.

The aramid, which may also be referred to as an aromatic polyamide, a polyaramid, or a para-aramid, may comprise a poly-p-phenylene terephthalamide, a poly-m-phenylene-terephthalamide, copoly-p-phenylene-3,4′-oxydiphenylene-terephthalamide, or mixed aliphatic-aromatic polyamides, such as poly-m-xylylene adipamide, poly-m-xylylene pimelamide, poly-m-xylylene azelamide, poly-p-xylylene azelamide, poly-p-xylylene decanamide, or combinations thereof. In some embodiments, the aramid comprises poly-p-phenylene terephthalamide.

By way of example only, the aramid may comprise poly-p-phenylene terephthalamide fibers, such as those commercially available under the KEVLAR® tradename from DuPont of Midland, Missouri, or those under the TWARON® tradename of Teijin Aramid B.V. (Arnhem, Netherlands). In some embodiments, the aramid is a pulp, such as a KEVLAR® pulp or a pulp form of TWARON® 1099 para-aramid. The aramid may have specific surface area in a range of from about 9 m²/g to about 13 m²/g with a fiber length of from about 0.9 mm to about 1.35 mm and a moisture content of from about 4% by weight to about 8% by weight.

The aramid may comprise a pulp that is formed from a filament yarn that is cut, suspended in water, and fibrillated. The pulp form of the poly-p-phenylene terephtalamide fibers is available as a wet pulp or a dry pulp and at various fiber lengths and various degrees of fibrillation. In some embodiments, the aramid acts as a low density filler in the precursor composition (and in the resulting insulation material) and improves the mechanical properties of the insulation formed from the precursor composition.

The aramid may be present in the precursor composition from about 5 weight percent to about 20 weight percent, such as from about 5 weight percent to about 10 weight percent, from about 10 weight percent to about 15 weight percent, or from about 15 weight percent to about 20 weight percent. In some embodiments, the aramid constitutes from about 10 weight percent to about 12 weight percent or from about 10 weight percent to about 11 weight percent of the precursor composition.

The curing agent, which may also be referred to herein as a curing compound or a curative, may include a peroxide compound that crosslines the polymeric material. In some embodiments, the curing agent comprises an organic peroxide compound. The curing agent may be commercially available from Arkema Inc. of Exton, Pennsylvania under the LUPEROX® tradename, or from Vanderbilt Chemicals, LLC of Norwalk Connecticut under the VAROX® tradename. By way of example only, the curing agent may comprise LUPEROX® 231 XL40, which is a 40% active dispersion of LUPEROX® 231 (1,1-di-(t-butylperoxy)-3,3,5-trimethylcyclohexane) polymer initiator on calcium carbonate. The 1,1-di-(t-butylperoxy)-3,3,5-trimethylcyclohexane polymer initiator may also be used in pure form, such as without the inert support. Alternatively, the curing agent may be dicumyl peroxide (DCP), which may be used in pure form or with an inert support.

The curing agent may constitute from about 1.0 weight percent to about 2.0 weight percent of the precursor composition, such as from about 1.0 weight percent to about 1.5 weight percent, or from about 1.5 weight percent to about 2.0 weight percent of the precursor composition. In some embodiments, the curing agent may constitute from about 1.2 weight percent to about 1.4 weight percent of the precursor composition.

The co-agent may include one or more of a polybutadiene resin, a linear polybutadiene, and a low volatility trifunctional monomer. In some embodiments, the co-agent comprises a linear polybutadiene, such as a homopolymer of polybutadiene. In some embodiments, the co-agent comprises a high vinyl polybutadiene, which is commercially available from Cray Valley USA, LLC of Exton, Pennsylvania under the RICON® tradename. By way of non-limiting example, the co-agent may include RICON® 134 polybutadiene. The co-agent may include an antioxidant, such as 3,6 ditertiary-butyl-4-methylphenol. In other embodiments, the co-agent comprises polybutadiene commercially available from Evonik of Essen, North Rhine-Westphalia, Germany. By way of non-limiting example, the co-agent may include a non-functionalized polybutadiene, such as Polyvest® 110. In other embodiments, the polybutadiene is functionalized.

In yet other embodiments, the co-agent includes a low volatility trifunctional monomer, such as trimethylolpropane trimethacrylate, which is commercially available from Sartomer Americas of Exton, Pennsylvania as SR350. In some embodiments, the precursor composition includes more than one co-agent.

The co-agent may constitute from about 5.0 to about 8.0 weight percent of the precursor composition, such as from about 5.0 weight percent to about 6.0 weight percent, from about 6.0 weight percent to about 7.0 weight percent, or from about 7.0 weight percent to about 8.0 weight percent of the precursor composition. In some embodiments, the co-agent constitutes from about from about 5.0 weight percent to about 6.0 weight percent of the precursor composition. In some embodiments, the co-agent constitutes greater than about 5.5 weight percent of the precursor composition.

The flame retardant may include one or more of a brominated compound, an iodinated compound, a fluorinated compound, or a compound including bromine and one or more of iodine, chlorine, and fluorine. In some embodiments, the flame retardant is substantially free of chlorine atoms. By way of non-limiting example, the flame retardant may include one or more of ethylenebistetrabromophthalimide, decabromodiphenyl ethane, a brominated styrene, a tetrabromobisphenol A bis (2,3-dibromopropyl ether), a bromine-containing diester/ether diol of tetrabromophthalic anhydride (e.g., a reactive diol including bromine, such as a compound having the formula C₁₅H₁₆O₇Br₄), tris(2,3-dibromoispropyl) isocyanurate (C₁₂H₁₅Br₆N₃O₃), and tetrabromobisphenol A.

In some embodiments, the flame retardant comprises ethylenebistetrabromophthalimide, such as that commercially available from Albemarle of Charlotte, North Carolina under the trade name SAYTEX®, such as SAYTEX® BT-93-W. The ethylenebistetrabromophthalimide may have the following chemical structure:

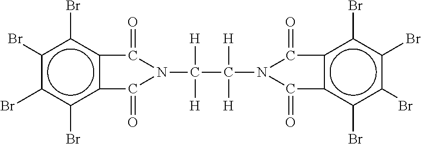

In some embodiments, the flame retardant comprises a brominated aromatic compound. For example, the flame retardant may comprise decabromodiphenyl ethane, which may be commercially available from Albemarle of Charlotte, North Carolina under the trade name SAYTEX® 8010, or from Lanxess of Cologne, Germany, under the trade name Firemaster® 2100 R. The flame retardant may have the following chemical structure:

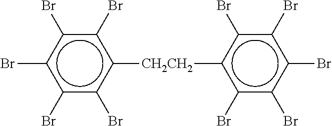

In some embodiments, the flame retardant comprises a brominated ethyl benzene compound, such as a brominated styrene. By way of non-limiting example, the flame retardant may be commercially available from Albemarle of Charlotte, North Carolina under the trade name SAYTEX®, such as SAYTEX® HP-7010. In some embodiments, the flame retardant comprises the following chemical structure:

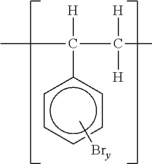

wherein x is an integral from about 1500 to about 2500, such as from about 1,500 to about 1,750, from about 1,750 to about 2,000, from about 2,000 to about 2,250, or from about 2,250 to about 2,500; and y is from about 2.5 to about 3.0, such as from about 2.5 to about 2.75, or from about 2.75 to about 3.0. In some embodiments, x is about 2,000 and y is about 2.7.

In some embodiments, the flame retardant comprises a tetrabromobisphenol A bis (2,3-dibromopropyl ether) compound containing aromatic and aliphatic bromine. The flame retardant may be commercially available from Dover Chemical Corporation of Dover, Ohio under the trade name DOVERGUARD® 68. The flame retardant may have the following chemical structure:

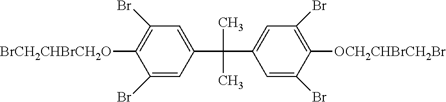

In some embodiments, the flame retardant comprises a brominated aliphatic compound. By way of nonlimiting example, the flame retardant may comprise a bromine-containing diester/ether diol of tetrabromophthalic anhydride (e.g., a reactive diol including bromine, such as a compound having the formula (C₁₅H₁₆O₇Br₄)). Such materials may be commercially available from Albemarle of Charlotte, North Carolina under the trade name SAYTEX®, such as SAYTEX® RB-79.

In some embodiments, the flame retardant comprises tetrabromobisphenol A. By way of non-limiting example, the flame retardant may be commercially available from Albemarle of Charlotte, North Carolina under the trade name SAYTEX® CP-2000. The flame retardant may have the following chemical structure:

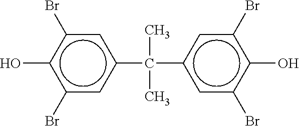

In some embodiments, the flame retardant comprises tris(2,3-dibromoisopropyl) isocyanurate, such as that commercially available from Nouryon of Amsterdam, Netherlands sold as Armoquell® FR930. The flame retardant may have the following chemical structure:

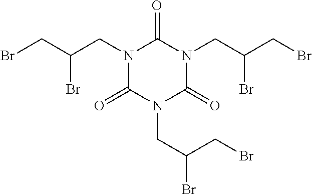 [SMILES: O=c1n(CC(Br)CBr)c(=O)n(CC(Br)CBr)c(=O)n1CC(Br)CBr]

In some embodiments, the flame retardant may comprise a chlorinated compound. In some embodiments, the chlorinated compound is in addition to a brominated compound. By way of nonlimiting example, the flame retardant comprises a linear aliphatic chlorinated compound. In some embodiments, the flame retardant comprises a perchlorinated compound. The flame retardant may be commercially available from Dover Chemical Corporation of Dover, Ohio under the trade name Chlorez® 700. In some embodiments, the flame retardant may comprise C₂₄H₂₈Cl₂₂. The flame retardant may have the following chemical structure:

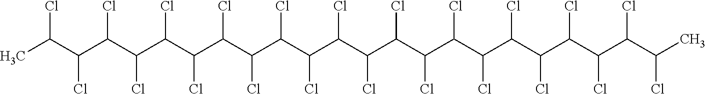 [SMILES: CC(Cl)C(Cl)C(Cl)C(Cl)C(Cl)C(Cl)C(Cl)C(Cl)C(Cl)C(Cl)C(Cl)C(Cl)C(Cl)C(Cl)C(Cl)C(Cl)C(Cl)C(Cl)C(Cl)C(Cl)C(Cl)C(C)Cl]

The flame retardant may have a molecular weight from about 500 g/mol to greater than about 2,000 g/mol, such as from about 500 g/mol to about 750 g/mol, from about 750 g/mol to about 1,000 g/mol, from about 1,000 g/mol to about 1,500 g/mol, or from about 1,500 g/mol to about 2,000 g/mol. In some embodiments, the molecular weight of the flame retardant is from about 700 g/mol to about 1,000 g/mol. However, the disclosure is not so limited and the molecular weight of the flame retardant may be different than (e.g., greater than) those described above. In some embodiments, such as where the flame retardant comprises a brominated styrene, the molecular weight of the flame retardant may be greater than about 2,000 g/mol, such as greater than about 100,000 g/mol, greater than about 200,000 g/mol, greater than about 300,000 g/mol, or even greater than about 400,000 g/mol.

The flame retardant may comprise less than about 30 atomic percent halogen, such as less than about 25 atomic percent, less than about 20 atomic percent, less than about 15 atomic percent, or less than about 10 atomic percent halogen. In some embodiments, the flame retardant comprises less than about 30 atomic percent or less than about 25 atomic percent bromine. As noted above, in some embodiments, the flame retardant is substantially free of chlorine. In some such embodiments, the flame retardant may comprise less than about 30 atomic percent atoms of fluorine, bromine, and iodine. Stated another way, the sum of the atomic percent of fluorine, bromine, and iodine may be less than about 30 atomic percent, such as less than about 25 atomic percent, less than about 20 atomic percent, less than about 15 atomic percent, or less than about 10 atomic.

The flame retardant may constitute from about 15 weight percent to about 40 weight percent of the precursor composition, such as from about 15 weight percent to about 20 weight percent, from about 20 weight percent to about 25 weight percent, from about 25 weight percent to about 30 weight percent, from about 30 weight percent to about 35 weight percent, or from about 35 weight percent to about 40 weight percent of the precursor composition. The brominated flame retardant may be a drop in replacement for a conventional chlorinated flame retardant in a conventional precursor composition. In some embodiments, the flame retardant constitutes greater than about 20 weight percent of the precursor composition, such as greater than about 21 weight percent, greater than about 22 weight percent, greater than about 25 weight percent, or greater than about 30 weight percent of the precursor composition.

The flame retardant may comprise from about 50 weight percent to about 90 weight percent bromine, such as from about 50 weight percent to about 60 weight percent, from about 60 weight percent to about 70 weight percent, from about 70 weight percent to about 80 weight percent, or from about 80 weight percent to about 90 weight percent bromine. In some embodiments, the flame retardant comprises greater than about 60 weight percent bromine, such as greater than about 70 weight percent bromine, or greater than about 75 weight percent bromine.

The flame retardants comprising the brominated organic materials may exhibit improved thermal properties compared to conventional chlorinated flame retardants. For example, in some embodiments, the flame retardant exhibits a weight loss of less than about 90 weight percent responsive to exposure to a temperature less than about 600° C. By way of comparison, conventional chlorinated flame retardants, exhibit a weight loss of about 90 weight percent responsive to exposure to a temperature between about 300° C. and about 400° C. In addition, the melting point of the flame retardant may be greater than about 400° C., such as greater than about 420° C., greater than about 440° C., greater than about 450° C., or greater than about 460° C. By way of comparison, the melting point of conventional flame retardant materials, such as conventional chlorinated flame retardants may be less than about 350° C.

The flame retardant may comprise a non-blooming material. In some such embodiments, the flame retardant may not migrate to the surface of the resulting insulation material during curing of the precursor composition and may not cause other components of the precursor composition to migrate to the surface during curing.

In some embodiments, the precursor composition may further include a flame retardant synergist (which may also be referred to herein as a “synergist”.) The synergist may comprise, for example, antimony trioxide (Sb₂O₃).

A molar ratio of the synergist to the halogen (e.g., bromine) (e.g., the moles of the synergist for every mole of the halogen) in the precursor composition may be within a range from about 2.9:1.0 to about 5.5:1.0, such as from about 2.9:1.0 to about 3.0:1.0, from about 3.0:1.0 to about 3.5:1.0, from about 3.5:1.0 to about 4.0:1.0, from about 4.0:1.0 to about 4.5:1.0, from about 4.5:1.0 to about 5.0:1.0, or from about 5.0:1.10 to about 5.5:1.0. In some embodiments, the molar ratio of the synergist to halogen is greater than about 4.0, such as greater than about 4.5, or greater than about 5.0.

The synergist may constitute from about 5.0 weight percent to about 15.0 weight percent of the precursor composition, such as from about 5.0 weight percent to about 7.5 weight percent, from about 7.5 weight percent to about 10.0 weight percent, from about 10.0 weight percent to about 12.5 weight percent, or from about 12.5 weight percent to about 15.0 weight percent. In some embodiments, the synergist constitutes less than about 10.0 weight percent of precursor composition, such as less than about 9.0 weight percent, less than about 8.0 weight percent, less than about 7.0 weight percent, or less than about 6.0 weight percent of the precursor composition.

The precursor composition may further include one or more of a filler, a processing aid, an antioxidant, a plasticizer, a cure accelerator, and a tackifier.

Non-limiting examples of fillers include one or more of zinc oxide, silica (silicon dioxide), magnesium hydroxide, carbon nanotubes, and carbon nanofibers. The fillers may comprise a powder, pellets, granules, or another form. In some embodiments, the filler comprises zinc oxide coated with propionic acid. The zinc oxide may have a surface area from about 4.0 m²/g to about 6.0 m²/g and a particle size from about 0.18 μm to about 0.27 μm. The zinc oxide may be commercially available from Zochem Inc. of Brampton, Canada as Zoco 672 or Zoco 627. In other embodiments, the filler comprises silica, which may be amorphous silica or precipitated silica, such as that commercially available from PPG Industries, Inc. of Pittsburgh, Pennsylvania under the HI-SIL® tradename. For example, silica fillers may comprise HI-SIL® 233 silica having a surface area (BET) of 135 m²/g. In embodiments where the filler comprises magnesium hydroxide, the magnesium hydroxide may be a non-halogenated, high purity powder, such as that commercially available from Martin Marietta Magnesia Specialties, LLC of Baltimore, Maryland under the MAGSHIELD® tradename. By way of example only, the magnesium hydroxide may be MAGSHIELD® S. The purity of the magnesium hydroxide may be greater than about 95%, such as greater than about 97% or greater than about 98%.

The one or more fillers may constitute from about 0.5 weight percent to about 10.0 weight percent of the precursor composition, such as from about 0.5 weight percent to about 1.0 weight percent, from about 1.0 weight percent to about 5.0 weight percent, or from about 5.0 weight percent to about 10.0 weight percent of the precursor composition.

Non-limiting examples of processing aids include, for example, a fatty acid or fatty acid derivative, such as that commercially available from PMC Biogenix, Inc. (Memphis, TN) under the INDUSTRENE® tradename. The fatty acid may be a stearic acid (C₁₇H₃₅CO₂H), such as INDUSTRENE® B. The stearic acid may constitute from about 0.35 weight percent to about 0.75 weight percent of the precursor composition.

Non-limiting examples of antioxidants include a hydroquinoline compound, such as a polymerized 1,2-dihydro-2,2,4-trimethylquinoline. The antioxidant may be commercially available from Vanderbilt Chemicals, LLC of Norwalk, Connecticut under the AGERITE® tradename. By way of example only, the antioxidant may be AGERITE® Resin D. The antioxidant may also be an amine compound, a phenol compound, another antioxidant, or combinations thereof, including combinations with the polymerized 1,2-dihydro-2,2,4-trimethylquinoline. The antioxidant may constitute, for example, from about 0.2 weight percent to about 1.0 weight percent of the precursor composition.

The plasticizer may be an aliphatic resin, such as those commercially available from Cray Valley of Exton, Pennsylvania under the WINGTACK® tradename. The aliphatic resin may be a five carbon (C5) petroleum hydrocarbon, such as WINGTACK® 95. The aliphatic resin may be constitute from about 4.0 parts weight percent to about 15.0 weight percent of the precursor composition, such as from about 8.0 weight percent to about 12.0 weight percent or from about 10.0 weight percent to about 11.0 weight percent of the precursor composition.

While specific examples of the co-agent, flame retardant synergist, curing agent, aramid, filler, processing aid, antioxidant, and plasticizer are provided above, materials other than those described above may be used depending on the desired shelf life of the uncured precursor composition or of the insulation, or on the desired mechanical properties of the insulation. The antioxidant may be selected depending on whether the precursor composition is to have an increased or decreased shelf life. Other co-agents and curing agents may be selected depending on the desired mechanical properties or cure temperature requirements of the insulation.

The precursor composition may be prepared by combining (e.g., mixing) the polymeric material, flame retardant (e.g., the brominated flame retardant), co-agent, flame retardant synergist, curing agents and aramid in a mixer, such as an internal mixer. The ingredients, including the flame retardant, may be homogeneously dispersed in the precursor composition. Shear in the mixer may generate a sufficient amount of heat to soften the polymeric material, enabling a homogeneous precursor composition to be formed without adding a solvent. Thus, the precursor composition may be prepared by a solvent-less process. Since no solvents are used, the precursor composition may be cured without performing a solvent removal process, such as drying or solvent evaporation.

The precursor composition may be shaped into its desired form, such as by extruding, calendaring, or compression molding. In some embodiments, the precursor composition is extrudable. The extrudability of the precursor composition may be comparable to that of the conventional insulation materials. The precursor composition may exhibit a sufficiently low viscosity such that the precursor composition has a flowable consistency before curing. As used herein, the term “flowable” means and includes a sufficiently low viscosity that enables the precursor composition to change shape or direction substantially uniformly in response to heat and/or shear, such that the precursor composition readily flows out of a container at room temperature. The flow behavior and extrudability of the precursor composition reduces the cost of manufacturing the rocket motor because the precursor composition or resulting insulation may be applied to the rocket motor by automated layup processes. By reducing or eliminating manual layup processes, the cost of manufacturing the rocket motor may be reduced. By way of example only, the precursor composition may be calendared to a desired thickness, such as a thickness of about 0.1 inch (about 0.254 cm). Once prepared, the precursor composition may be applied to the rocket motor or other article and cured. Alternatively, the precursor composition may be stored until use. The precursor composition may be used as internal insulation or external insulation of a rocket motor (e.g., the rocket motor 100 (FIG. 1), the rocket motor nozzle (FIG. 2)), or as a shear ply depending on the configuration of the rocket motor. The precursor composition may be used as a shear ply to couple a case of the rocket motor to a rocket skirt. The precursor composition may be applied to the rocket motor by hand layup or by automated layup processes.

The precursor composition may include fewer ingredients (components) than conventional insulation materials, reducing the cost and complexity of manufacturing an article including the insulation. In some embodiments, the precursor composition may include fewer than 10 ingredients, such as fewer than 9 ingredients, fewer than 8 ingredients, or fewer than 7 ingredients. In some embodiments, the precursor composition comprises 6 ingredients, including the polymeric material (EPDM), the co-agent, the flame retardant, the antimony trioxide, the curing agent, and the aramid. For example, the precursor composition may consist or consist essentially of the polymeric material, the flame retardant, the co-agent, the flame retardant synergist, the curing agent, and the aramid. By way of comparison, conventional insulation precursor materials including a conventional chlorinated flame retardant may include more than 10 ingredients, such as at least 16 ingredients.

In some embodiments, the precursor composition according to embodiments of the disclosure includes fewer moles of halogen than a conventional chlorinated flame retardant material for the same weight of insulation, while the insulation material according to embodiments of the disclosure and formed from the flame retardant exhibits similar or improved thermal characteristics compared to insulation materials formed from conventional chlorinated flame retardants.

The insulation materials 104, 204 (FIG. 1, FIG. 2) formed from the precursor composition according to embodiments described herein may exhibit comparable or improved mechanical, thermal, bonding, char and erosion, and ablative properties compared to conventional insulation materials. For example, the insulation materials 104, 204 may exhibit improved tensile stress properties, similar elongation properties, may exhibit a similar glass transition temperature as conventional insulation materials formed with conventional chlorinated flame retardants, may exhibit a similar coefficient of thermal expansion above and below the glass transition temperature as conventional insulation materials formed with conventional chlorinated flame retardants, and use less flame retardant synergist than conventional insulation materials. In addition, the insulation materials 104, 204 formed from the precursor composition according to embodiments described herein may decompose (such as under thermogravimetric analysis (TGA)) at higher temperatures than conventional insulation materials formed using chlorinated flame retardants. Further, the insulation materials 104, 204 formed from the precursor composition according to embodiments described herein exhibit improved bonding to the liner (e.g., the liner 106 (FIG. 1)) and to the casing (e.g., the casing 102 (FIG. 1)). In addition, the insulation materials 104, 204 formed from the precursor composition according to embodiments described herein may exhibit similar or improved properties as conventional insulation materials formed with chlorinated flame retardants, but may include fewer moles of bromine than moles of chlorine included in conventional insulation materials.

In some embodiments, the insulation materials 104, 204 including the bromine-containing flame retardant may exhibit a lower thermal conductivity than conventional insulation materials formed with chlorinated flame retardants. Accordingly, in some embodiments, a rocket motor (e.g., the rocket motor 100 (FIG. 1)) may include a lower volume of the insulation material for the same amount of energetic material (e.g., the energetic material 108 (FIG. 1)) while achieving similar thermal insulative properties. By way of nonlimiting example, the thermal conductivity of the insulation materials 104, 204 may be from about 0.170 W/m-K to about 0.180 W/m-K, such as from about 0.170 W/m-K to about 0.172 W/m-K, from about 0.172 W/m-K to about 0.174 W/m-K, from about 0.174 W/m-K to about 0.176 W/m-K, from about 0.176 W/m-K to about 0.178 W/m-K, or from about 0.178 W/m-K to about 0.180 W/m-K.

In addition, the insulation materials 104, 204 (FIG. 1, FIG. 2) formed from the precursor composition according to the embodiments described herein may exhibit similar properties with respect to solvent (e.g., isopropyl alcohol, xylene, acetone, ethyl acetate, methylene chloride) and plasticizer (e.g., dioctyl sebacate (DOS), dioctyl adipate (DOA), isodecyl pelargonate (IDP)) uptake as insulation materials formed with conventional chlorinated flame retardants. In other words, the insulation materials 104, 204 formed from the precursor composition according to the embodiments described herein have similar solvent and plasticizer uptake profiles (e.g., exhibit a similar increase in weight as a function of time when exposed to solvent and plasticizers) as insulation materials formed with conventional chlorinated flame retardants.

Since the flame retardant includes materials that are not subject to obsolescence concerns, such as various chlorinated flame retardants, the insulation materials 104, 204 (FIG. 1, FIG. 2) may be formed with the precursor compositions that include flame retardants that replace conventional chlorinated flame retardants while exhibiting similar or better thermal protection properties as conventional insulation materials.

Although the precursor compositions have been described as being used for insulation materials in rocket motors (e.g., the rocket motor 100 (FIG. 1) and the rocket motor nozzle 200 (FIG. 2)), the disclosure is not so limited. For example, in addition to being used as insulation in rocket motors, the insulation materials 104, 204 (FIG. 1, FIG. 2) may be used in other articles where protection from heat and gases is desired. For example, the insulation materials 104, 204 may be used for heat and gas protection in under-the-hood applications in automobiles. The insulation materials 104, 204 may also be used in conveyor belts and in noise-damping applications in automobile and other fields. In addition, since the insulation materials 104, 204 may be extruded, compression molded, or calendared, the insulation materials 104, 204 may be used in routine rubber applications including, but not limited to, such applications as hoses, gaskets, seals, isolators and mounts, cushions, air emission hoses, and dock fenders.

### EXAMPLES

### Example 1

Precursor compositions including varying amounts of different flame retardants were prepared and cured to form insulation materials. Table I includes the ingredients of the precursor compositions that were formed. The numbers at the top of the columns represent the sample numbers of the compositions. The numbers, other than the numbers in the last row (Sb₂O₃:halogen), represent the weight percent of the particular component in the precursor composition.

TABLE I

| Component | 1 | 2 | 3 | 4 | 5 | 6 | 7 | 8 | 9 | 10 |
|---|---|---|---|---|---|---|---|---|---|---|
| EPDM | 51.9 | 52 | 54.5 | 55.9 | 51.9 | 36.6 | 51.9 | 46.5 | 46.6 | 53 |
| Co-agent | 5.2 | 5.2 | 5.4 | 6.7 | 5.2 | 5.1 | 5.2 | 5.2 | 5.1 | 5.8 |
| (polybutadiene) | | | | | | | | | | |
| Decabromodiphenyl | 0 | 21 | 18.5 | 17.3 | 24.4 | 36.6 | | 13.7 | 0 | 0 |
| ethane | | | | | | | | | | |
| Chlorez 700S | 0 | 0 | 0 | 0 | 0 | 0 | 20.8 | 12.3 | 0 | 0 |
| Ethylenebistetra- | 0 | 0 | 0 | 0 | 0 | 0 | 0 | 0 | 29.8 | 23.8 |
| bromophthalimide | | | | | | | | | | |
| Dechlorane plus | 20.8 | 0 | 0 | 0 | 0 | 0 | 0 | 0 | 0 | 0 |
| antimony trioxide | 10.4 | 10 | 9.3 | 8.7 | 6.8 | 10.3 | 10.4 | 10.5 | 7 | 5.6 |
| Curing agent | 1.3 | 1.3 | 1.4 | 1.4 | 1.3 | 1.3 | 1.3 | 1.3 | 1.2 | 1.3 |
| aramid pulp | 10.4 | 10 | 10.9 | 10.1 | 10.4 | 10.1 | 10.4 | 10.5 | 10.3 | 10.4 |
| Sb₂O₃:halogen (mols) | 5.35:1 | 3:1 | 2.98:1 | 2.98:1 | 5.43:1 | 5.33:1 | 4.24:1 | 5.38:1 | 5.23:1 | 5.2:1 |

The mechanical properties of insulation materials formed from various precursor compositions were measured. The precursor compositions included those described above with reference to Table I, in addition to other compositions. Table II lists the tensile properties, density, and shore A hardness of insulation materials formed from the precursor compositions in Table I (Sample 1 through Sample 10) in addition to additional precursor compositions, which include various halogenated flame retardants. The precursor compositions included EPDM, aramid pulp, a co-agent, a curing agent, antimony trioxide, and the listed flame retardants.

TABLE II

| | Tensile | | | |
|---|---|---|---|---|
| | strength | Elongation | | |
| | at 25° C. | (at 25° C.) | Density | Shore A |
| Flame Retardant | (psi) | (percent) | (lb/in³) | Hardness |
| Sample 1 | 2453 | 15 | 0.041 | 88.9 |
| Sample 7 | 1662 | 33 | 0.041 | 84 |
| Sample 2 | 3039 | 24 | 0.404 | 83.2 |
| Sample 3 | 3449 | 16 | 0.0425 | 84.8 |
| Sample 4 | 3289 | 19 | 0.0417 | 82.8 |
| Sample 5 | 3022 | 16 | 0.0436 | 87.4 |
| Sample 6 | 4239 | 7 | 0.0523 | 89.4 |
| Sample 8 | 2067 | 17 | 0.0443 | 82 |
| Sample 9 | 2475 | 13 | 0.0454 | 89 |
| Sample 10 | 3302 | 10 | 0.0424 | 85.6 |
| Ethylenebistetra- | 3087 | 13 | 0.0424 | 86 |
| bromophthalimide | | | | |
| Ethylenebistetra- | 2562 | 14 | 0.0424 | 88.2 |
| bromophthalimide | | | | |
| Ethylenebistetra- | 2721 | 12 | 0.0425 | 87.4 |
| bromophthalimide | | | | |
| Ethylenebistetra- | 2638 | 14 | 0.0424 | 89.6 |
| bromophthalimide | | | | |
| Ethylenebistetra- | 2359 | 19 | 0.0423 | 86.4 |
| bromophthalimide | | | | |
| Ethylenebistetra- | 3022 | 15 | 0.0424 | 85.8 |
| bromophthalimide | | | | |
| Ethylenebistetra- | 3413 | 13 | 0.0424 | 85.6 |
| bromophthalimide | | | | |

The samples including the ethylenebistetrabromophthalimide included similar compositions as that of Sample 10, but with differing amounts of the ethylenebistetrabromophthalimide flame retardant. Most of the samples including the brominated flame retardant (decabromodiphenyl ethane or ethylenebistetrabromophthalimide; i.e., Sample 2 through Sample 6, Sample 8 through Sample 10, and the samples including the ethylenebistetrabromophthalimide) exhibited a higher tensile strength compared to the insulation materials including a chlorinated flame retardant (Sample 1 and Sample 7). Accordingly, the tensile strength, and the corresponding bond in tension (BIT) of the insulation materials formed from flame retardants comprising bromine was improved compared to insulation materials formed with conventional chlorinated flame retardant materials.

The samples including the brominated flame retardant exhibited similar Shore A Hardness as those containing chlorinated flame retardants. The density of the insulation was tailored with the various additives and amount of the flame retardant. Accordingly, insulation materials formed with the bromine-containing flame retardants described herein may not have a higher weight than insulation materials formed with conventional halogenated flame retardants.

### Example 2

Insulation materials were formed from a precursor composition comprising about 53.0 weight percent EPDM, about 5.8 weight percent co-agent comprising polybutadiene, about 28.8 weight percent ethylenebistetrabromophthalate flame retardant, about 5.6 weight percent antimony trioxide, about 1.4 weight percent curing agent, and about 10.4 weight percent aramid pulp. An insulation material was formed from a conventional precursor composition including about 51.9 weight percent EPDM, about 5.2 weight percent co-agent comprising polybutadiene, about 20.8 weight percent conventional flame retardant comprising Dechlorane Plus® (a chlorine-containing flame retardant), about 10.4 weight percent antimony trioxide, about 1.3 weight percent curing agent, and about 10.4 weight percent aramid pulp. Each of the insulation materials were bonded to a propellant. The bond in tension of the insulation material including the ethylenebistetrabromophthalate flame retardant was compared to the bond in tension of the insulation material including the chlorine-containing flame retardant. The insulation material including the ethylenebistetrabromophthalate flame retardant exhibited similar bond in tension characteristics as the insulation material including the chlorine-containing flame retardant. In both instances, the propellant material failed before failure of the bond between the propellant material and the insulation material.

### Example 3

The char and erosion characteristics of insulation materials including a flame retardant comprising ethylenebistetrabromophthalate and was compared to the char and erosion characteristics of conventional insulation materials including a flame retardant comprising Dechlorane Plus®. Test motors comprising a first chamber carrying a propellant and a second chamber simulating a nozzle were used. A first radial half (180°) of the nozzle was lined with the insulation material including the ethylenebistetrabromophthalate flame retardant and a second radial half (180°) of the nozzle was lined with the insulation material including the Dechlorane Plus® flame retardant. The amount of the insulation that was lost (degraded) at various locations in the test motor was measured and the mass flux at each such location was plotted against the amount of insulation that was lost at that particular location.

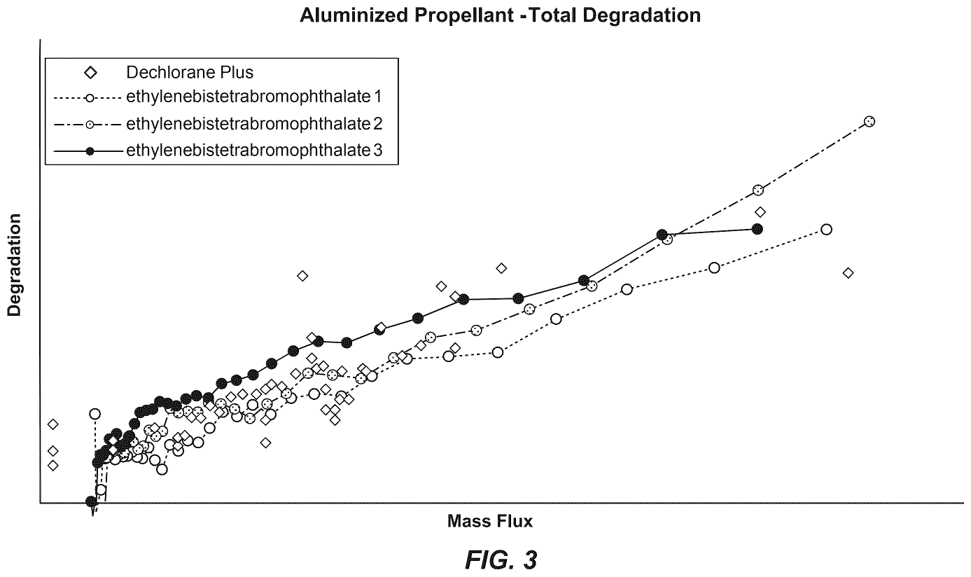

FIG. 3 is a graph of the degradation of various insulation materials as a function of mass flux passing the insulation materials. The propellant that was combusted comprises an aluminized hydroxyl-terminated polybutadiene (HTPB) composite solid propellant. The insulation materials included the insulation material of Sample 1 above and three different insulation materials comprising the same composition as Sample 10 above. The insulation material including the Dechlorane Plus® flame retardant exhibited a greater amount of degradation than insulation materials including the ethylenebistetrabromophthalate flame retardant, particularly at increased mass fluxes.

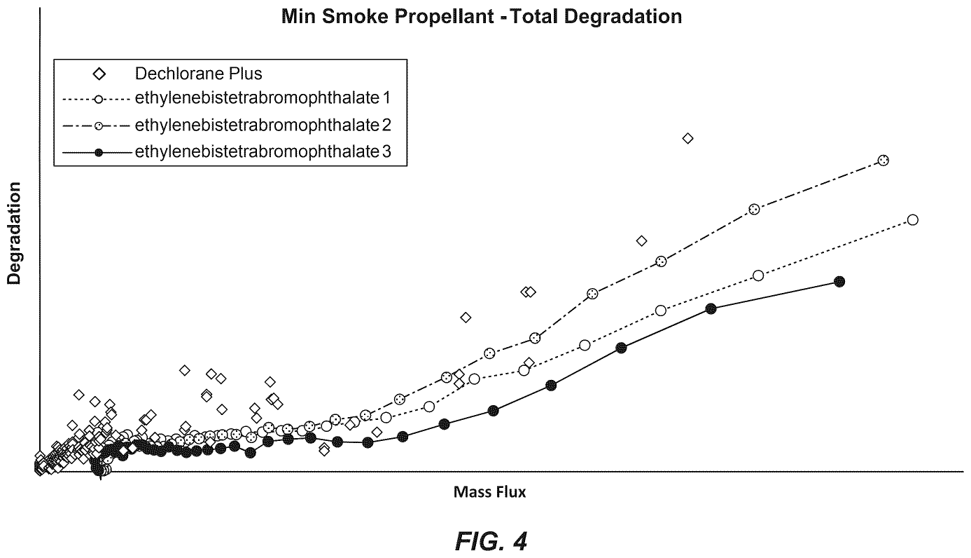

FIG. 4 is a graph of the degradation of same insulation materials of FIG. 3 as a function of mass flux when exposed to exhaust from a minimum smoke solid propellant. The minimum smoke solid propellant included a nitrate ester for reducing the smoke. The insulation materials including the ethylenebistetrabromophthalate flame retardant exhibited less total degradation than the insulation materials including the Dechlorane Plus® flame retardant.

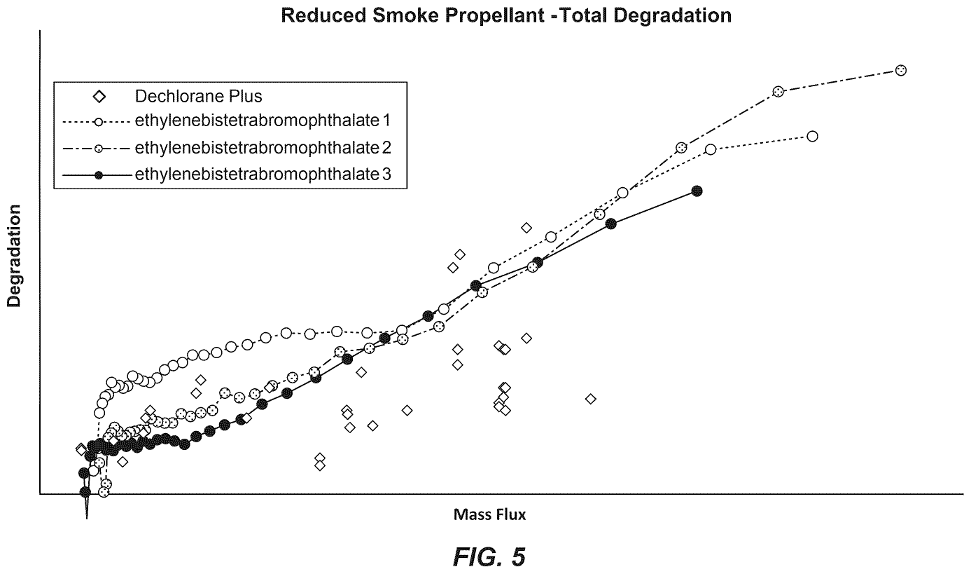

FIG. 5 is a graph of the degradation of the same insulation materials of FIG. 3 as a function of mass flux when exposed to exhaust from a reduced smoke solid propellant comprising a HTPB composite solid fuel. The insulation materials including the ethylenebistetrabromophthalate flame retardant exhibited less total degradation than the insulation materials including the Dechlorane Plus® flame retardant.

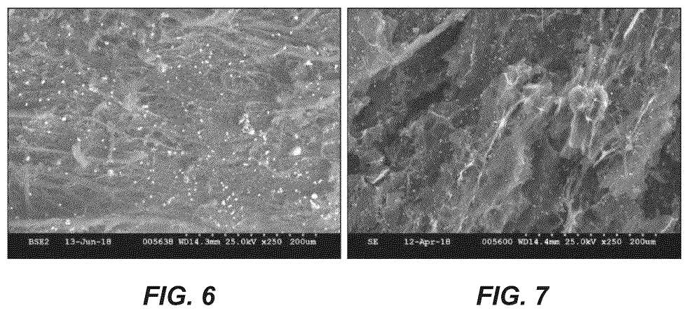

FIG. 6 and FIG. 7 are SEM images of the insulation material including the ethylenebistetrabromophthalate flame retardant and the insulation material including the Dechlorane Plus® flame retardant, respectively, after exposure to propellant combustion gases. As shown in FIG. 6, the insulation material including the ethylenebistetrabromophthalate flame retardant appears to have more tightly bound particles and fibers while the insulation material including the Dechlorane Plus® flame retardant (FIG. 7) appears to include clear separation between layers. It was observed that the insulation materials including the Dechlorane Plus® flame retardant included layers that flaked off after exposure to the propellant gases.

### Example 4

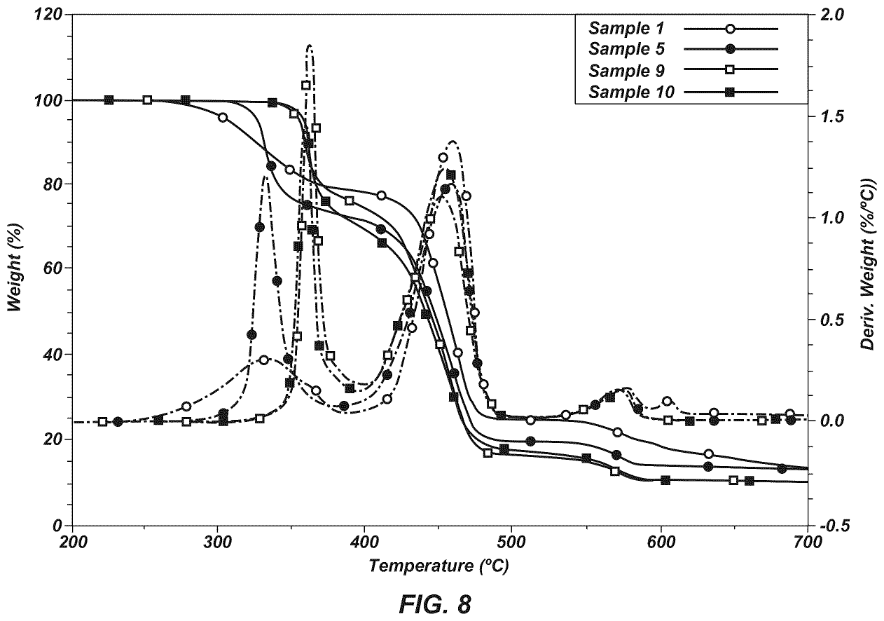

The thermal properties of the insulation material of Sample 1 was compared to the thermal properties of the insulation materials of Sample 5, Sample 9, and Sample 10. FIG. 8 is a graph illustrating the thermogravimetric curves of each sample and shows the percent weight loss of each sample as a function of temperature. Samples 9 and 10, which include ethylenebistetrabromophthalimide appear to exhibit less weight loss responsive to exposure to temperatures less than about 350° C., as indicated in box 800. The dashed lines in FIG. 8 represent the change in weight percent at a particular temperature while the solid lines represent the cumulative change in weight of the samples as the samples are exposed to increasing temperatures.

### Example 5

The thermal conductivity of the insulation materials of Sample 1, Sample 5, Sample 9, and Sample 10 were measured and are shown in Table III below.

TABLE III

| | Thermal | Thermal |
|---|---|---|
| | Conductivity at 27° C. | Conductivity at 87° C. |
| Sample | (W/m-K) | (W/m-K) |
| 1 | 0.176 ± 0.005 | 0.176 ± 0.005 |
| 5 | 0.174 ± 0.003 | 0.175 ± 0.004 |
| 9 | 0.174 ± 0.002 | 0.176 ± 0.002 |
| 10 | 0.174 ± 0.003 | 0.178 ± 0.003 |

The thermal conductivity of the insulation materials including the ethylenebistetrabromophthalate flame retardant and the decabromodiphenyl ethane flame retardant were lower than or about equal to the thermal conductivity of the insulation material including the chlorinated flame retardant.

While the disclosure is susceptible to various modifications and alternative forms, specific embodiments have been shown by way of example in the drawings and have been described in detail herein. However, the disclosure is not intended to be limited to the particular forms disclosed. Rather, the disclosure is to cover all modifications, equivalents, and alternatives falling within the scope of the disclosure as defined by the following appended claims and their legal equivalents.

What is claimed is:

1. An insulation precursor composition, comprising:
a terpolymer of ethylene, propylene, and a non-conjugated diene in an amount of from about 45 weight percent to about 60 weight percent of the insulation precursor composition;
an aramid in an amount of from about 5 weight percent to about 20 weight percent of the insulation precursor composition;
one or more bromine-containing flame retardants chosen from ethylenebistetrabromophthalimide, decabromodiphenyl ethane, a bromine-containing diester/ester diol of tetrabromophthalic anhydride having the chemical formula C₁₅H₁₆O₇Br₄, tris(2,3-dibromoisopropyl) isocyanurate (C₁₂H₁₅Br₆N₃O₃), tetrabromobisphenol A, tetrabromobisphenol A bis(2,3-dibromopropyl ether), a brominated styrene, or a combination thereof;
one or more peroxide compounds;
antimony trioxide in an amount of from about 4 moles to about 5 moles for every about 1 mole of bromine in the one or more bromine-containing flame retardants; and
at least one of polybutadiene resin, a linear polybutadiene, and a low volatility trifunctional monomer,
wherein after curing, the insulation precursor composition provides an insulation material having a heat protection performance suitable for use in a rocket motor.

2. The insulation precursor composition of claim 1, wherein the insulation precursor composition comprises the terpolymer of ethylene, propylene, and the non-conjugated diene, poly-p-phenylene terephthalamide, one or more of ethylenebistetrabromophthalimide and decabromodiphenyl ethane, an organic peroxide compound, the antimony trioxide, and the polybutadiene resin.

3. The insulation precursor composition of claim 1, wherein the bromine-containing flame retardant comprises ethylenebistetrabromophthalimide.

4. The insulation precursor composition of claim 1, wherein the bromine-containing flame retardant comprises decabromodiphenyl ethane.

5. The insulation precursor composition of claim 1, wherein the insulation precursor composition comprises the bromine-containing flame retardant at from about 15 weight percent to about 40 weight percent of the insulation precursor composition.

6. The insulation precursor composition of claim 1, wherein the insulation precursor composition comprises the antimony trioxide at from about 5.6 weight percent to about 10.5 weight percent of the insulation precursor composition.

7. The insulation precursor composition of claim 1, wherein the insulation precursor composition comprises the aramid at from about 5 weight percent to about 15 weight percent of the insulation precursor composition.

8. The insulation precursor composition of claim 1, wherein the insulation precursor composition lacks a solvent.

9. An insulation precursor composition, comprising:
a polymeric material in an amount of from about 45 weight percent to about 60 weight percent of the insulation precursor composition;
an aramid in an amount of from about 5 weight percent to about 20 weight percent of the insulation precursor composition;
a bromine-containing flame retardant comprising decabromodiphenyl ethane, ethylenebistetrabromophthalimide, ethylenebistetrabromophthalate, or a combination thereof;
one or more peroxide compounds;
antimony trioxide in an amount of from about 4 moles to about 5 moles for every about 1 mole of bromine in the bromine-containing flame retardant; and
polybutadiene,
wherein after curing, the insulation precursor composition provides an insulation material having a heat protection performance suitable for use in a rocket motor.

10. The insulation precursor composition of claim 9, wherein the polymeric material comprises one or more of a terpolymer of ethylene propylene diene monomer, polyisoprene, nitride butadiene rubber, and hydroxyl-terminated polybutadiene rubber.

11. The insulation precursor composition of claim 9, wherein the polymeric material comprises a terpolymer of ethylene, propylene, and a non-conjugated diene and the bromine-containing flame retardant comprises decabromodiphenyl ethane.

12. The insulation precursor composition of claim 9, wherein the polymeric material comprises a terpolymer of ethylene, propylene, and a non-conjugated diene and the bromine-containing flame retardant comprises ethylenebistetrabromophthalimide.

13. The insulation precursor composition of claim 9, wherein the polymeric material comprises a terpolymer of ethylene, propylene, and a non-conjugated diene and the bromine-containing flame retardant comprises ethylenebistetrabromophthalate.

14. The insulation precursor composition of claim 9, wherein the aramid comprises poly-p-phenylene terephthalamide fibers or poly-p-phenylene terephthalamide pulp.

15. The insulation precursor composition of claim 9, wherein the bromine-containing flame retardant is substantially free of chlorine.

16. An insulation precursor composition, comprising:
a terpolymer of ethylene, propylene, and a non-conjugated diene in an amount of from about 45 weight percent to about 60 weight percent of the insulation precursor composition;
poly-p-phenylene terephthalamide in an amount of from about 5 weight percent to about 20 weight percent of the insulation precursor composition;
one or more of ethylenebistetrabromophthalimide and decabromodiphenyl ethane;
one or more peroxide compounds;
antimony trioxide in an amount of from about 4 moles to about 5 moles for every about 1 mole of bromine in the one or more of ethylenebistetrabromophthalimide and decabromodiphenyl ethane; and
at least one of polybutadiene resin, a linear polybutadiene, and a low volatility trifunctional monomer,
wherein after curing, the insulation precursor composition provides an insulation material having a heat protection performance suitable for use in a rocket motor.

17. The insulation precursor composition of claim 16, wherein the poly-p-phenylene terephthalamide comprises fibers or a pulp.

18. The insulation precursor composition of claim 16, wherein the insulation precursor composition comprises the one or more of ethylenebistetrabromophthalimide and decabromodiphenyl at from about 20 weight percent to about 35 weight percent of the insulation precursor composition.

19. The insulation precursor composition of claim 16, wherein the insulation precursor composition comprises the one or more of ethylenebistetrabromophthalimide and decabromodiphenyl at from about 10 weight percent to about 35 weight percent of the insulation precursor composition.

20. The insulation precursor composition of claim 16, wherein the insulation precursor composition comprises less than about 15.0 weight percent of the antimony trioxide.
